(19) United States
(12) Patent Application Publication
(10) Pub. No.: US 2014/0336940 A1
(43) Pub. Date: Nov. 13, 2014

(54) ESTIMATION OF Q-FACTOR IN TIME DOMAIN

(71) Applicant: SCHLUMBERGER TECHNOLOGY CORPORATION, SUGAR LAND, TX (US)

(72) Inventors: PIERRE BETTINELLI, LE PUGET SUR ARGENS (FR); JEAN-CLAUDE PUECH, PAU (FR)

(73) Assignee: SCHLUMBERGER TECHNOLOGY CORPORATION, SUGAR LAND, TX (US)

(21) Appl. No.: 14/272,362

(22) Filed: May 7, 2014

Related U.S. Application Data
(60) Provisional application No. 61/821,887, filed on May 10, 2013.

(51) Int. Cl. G01V 1/28

(52) U.S. Cl. CPC G01V 1/282
USPC 702/14

(57) ABSTRACT

A method can include receiving seismic traces associated with a geologic environment; determining time domain stretch values for individual wavelets in at least a portion of the seismic traces with respect to a spatial dimension of the geologic environment; and estimating at least one Q-factor value for at least a portion of the geologic environment via a comparison of the time domain stretch values to a Q-factor model.

### CROSS-REFERENCE TO RELATED APPLICATION

This application claims the benefit of U.S. Provisional Patent Application Ser. No. 61/821,887 filed 10 May 2013, which is incorporated herein by reference in its entirety.

### BACKGROUND

Reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Various techniques described herein pertain to processing of data such as, for example, seismic data.

### SUMMARY

In accordance with some embodiments, a method is performed that includes: receiving seismic traces associated with a geologic environment; determining time domain stretch values for individual wavelets in at least a portion of the seismic traces with respect to a spatial dimension of the geologic environment; and estimating at least one Q-factor value for at least a portion of the geologic environment via a comparison of the time domain stretch values to a Q-factor model.

In accordance with some embodiments, a system is provided that includes a processor; memory accessibly by the processor; one or more modules storable in the memory where the one or more modules includes processor-executable instructions to instruct the system to receive seismic traces associated with a geologic environment; determine time domain stretch values for individual wavelets in at least a portion of the seismic traces with respect to a spatial dimension of the geologic environment; and estimate at least one Q-factor value for at least a portion of the geologic environment via a comparison of the time domain stretch values to a Q-factor model.

In some embodiments, an aspect includes seismic traces of a vertical seismic profile (VSP).

In some embodiments, an aspect includes individual wavelets that include downgoing direct arrival wavelets.

In some embodiments, an aspect includes individual time domain stretch values that include a respective time difference value between a trough of an individual wavelet and a peak of the individual wavelet.

In some embodiments, an aspect includes individual time domain stretch values that include a respective time difference value between two points of an individual first downgoing P-wave arrival wavelet.

In some embodiments, an aspect includes individual time domain stretch values that include a respective time difference between two inflection points of an individual wavelet.

In some embodiments, an aspect involves autocorrelating seismic traces.

In some embodiments, an aspect involves receiving autocorrelated seismic traces.

In some embodiments, an aspect includes seismic traces that include pneumatic energy source generated seismic traces.

In some embodiments, an aspect includes seismic traces that include vibroseis seismic traces.

In some embodiments, an aspect involves applying reverse Q-filtering to at least a portion of seismic traces using at least one estimated Q-factor values.

In some embodiments, an aspect includes processor-executable instructions to instruct a system to generate a Q-factor model that may include model information for a plurality of Q-factor values.

In some embodiments, an aspect includes processor-executable instructions to instruct a system to perform reverse Q-filtering.

In some embodiments, an aspect includes processor-executable instructions to instruct a system to acquire seismic traces.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for modeling a geologic environment;

FIG. 2 illustrates examples of formations, an example of a convention for dip, an example of data acquisition, and an example of a system;

FIG. 3 illustrates an example of a technique and associated data and signals;

FIG. 4 illustrates an example of a geologic environment, an example of a cycle loss model and examples of wavelets;

FIG. 5 illustrates examples of survey techniques;

FIG. 6 illustrates an example of a survey technique;

FIG. 7 illustrates an example of a survey technique that may optionally be performed during a drilling operation;

FIG. 8 illustrates examples of spectra and examples of methods;

FIG. 9 illustrates an example of a method;

FIG. 10 illustrates an example of a method;

FIG. 11 illustrates examples of plots of data and model information;

FIG. 12 illustrates examples of plots for a variety of Q-factor values;

FIG. 13 illustrates examples of plots with respect to spectral analyses;

FIG. 14 illustrates examples of plots associated with reverse Q-filtering; and

FIG. 15 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

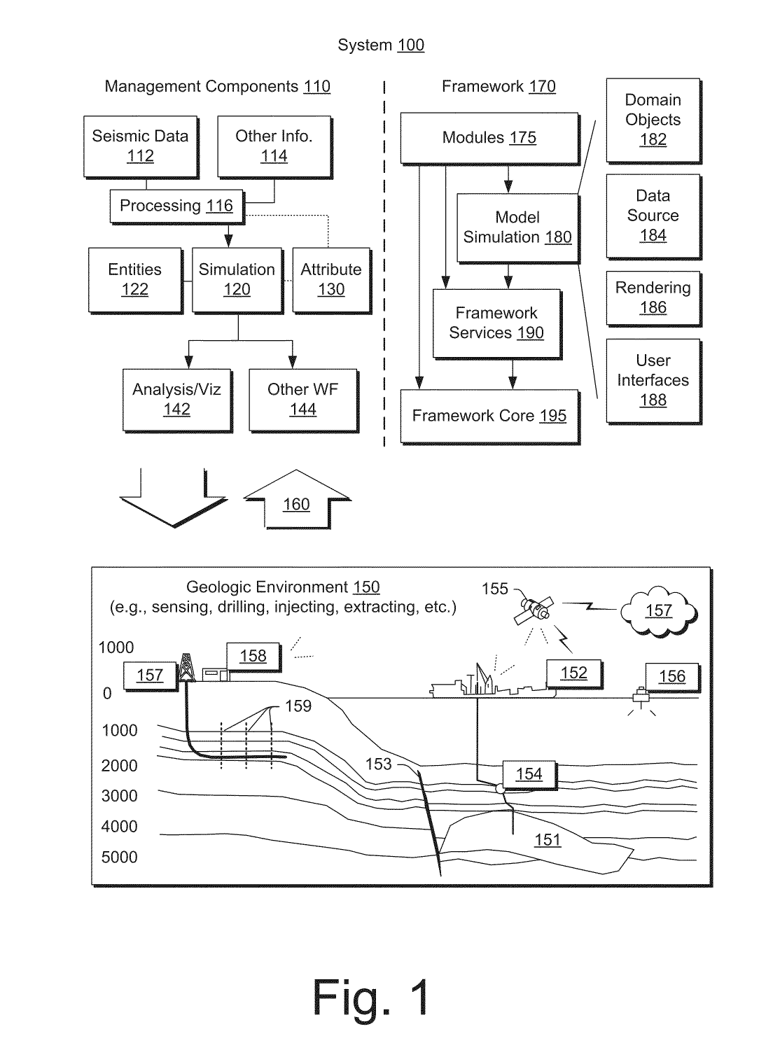

FIG. 1 shows an example of a system 100 that includes various management components 110 to manage various aspects of a geologic environment 150 (e.g., an environment that includes a sedimentary basin, a reservoir 151, one or more fractures 153, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may rely on a software framework such as an object-based framework. In such a framework, entities may include entities based on pre-defined classes to facilitate modeling and simulation. A commercially available example of an object-based framework is the MICROSOFT™ .NET™ framework (Redmond, Wash.), which provides a set of extensible object classes. In the .NET™ framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results. As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Tex.), the INTERSECT™ reservoir simulator (Schlumberger Limited, Houston Tex.), etc. As an example, a reservoir or reservoirs may be simulated with respect to one or more enhanced recovery techniques (e.g., consider a thermal process such as SAGD, etc.).

In an example embodiment, the management components 110 may include features of a commercially available simulation framework such as the PETREL™ seismic to simulation software framework (Schlumberger Limited, Houston, Tex.). The PETREL™ framework provides components that allow for optimization of exploration and development operations. The PETREL™ framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment).

In an example embodiment, various aspects of the management components 110 may include add-ons or plug-ins that operate according to specifications of a framework environment. For example, a commercially available framework environment marketed as the OCEAN™ framework environment (Schlumberger Limited, Houston, Tex.) allows for integration of add-ons (or plug-ins) into a PETREL™ framework workflow. The OCEAN™ framework environment leverages .NET™ tools (Microsoft Corporation, Redmond, Wash.) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN™ framework where the model simulation layer 180 is the commercially available PETREL™ model-centric software package that hosts OCEAN™ framework applications. In an example embodiment, the PETREL™ software may be considered a data-driven application. The PETREL™ software can include a framework for model building and visualization. Such a model may include one or more grids.

The model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

In the example of FIG. 1, the domain objects 182 can include entity objects, property objects and optionally other objects. Entity objects may be used to geometrically represent wells, surfaces, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include the reservoir 151 and that may be intersected by a fault 153 (see also, e.g., the one or more fractures 159, which may intersect a reservoir). As an example, a geologic environment may be or include an offshore geologic environment, a seabed geologic environment, an ocean bed geologic environment, etc.

As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more of the one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc., may exist where an assessment of such variations may assist with planning, operations, etc., to develop the reservoir (e.g., via fracturing, injecting, extracting, etc.). As an example, the equipment 157 and/or 158 may include components, a system, systems, etc., for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL™ software, for example, that operates on seismic data, seismic attribute(s), etc. As an example, a workflow may be a process implementable in the OCEAN™ framework. As an example, a workflow may include one or more worksteps that access a module such as a plug-in (e.g., external executable code, etc.).

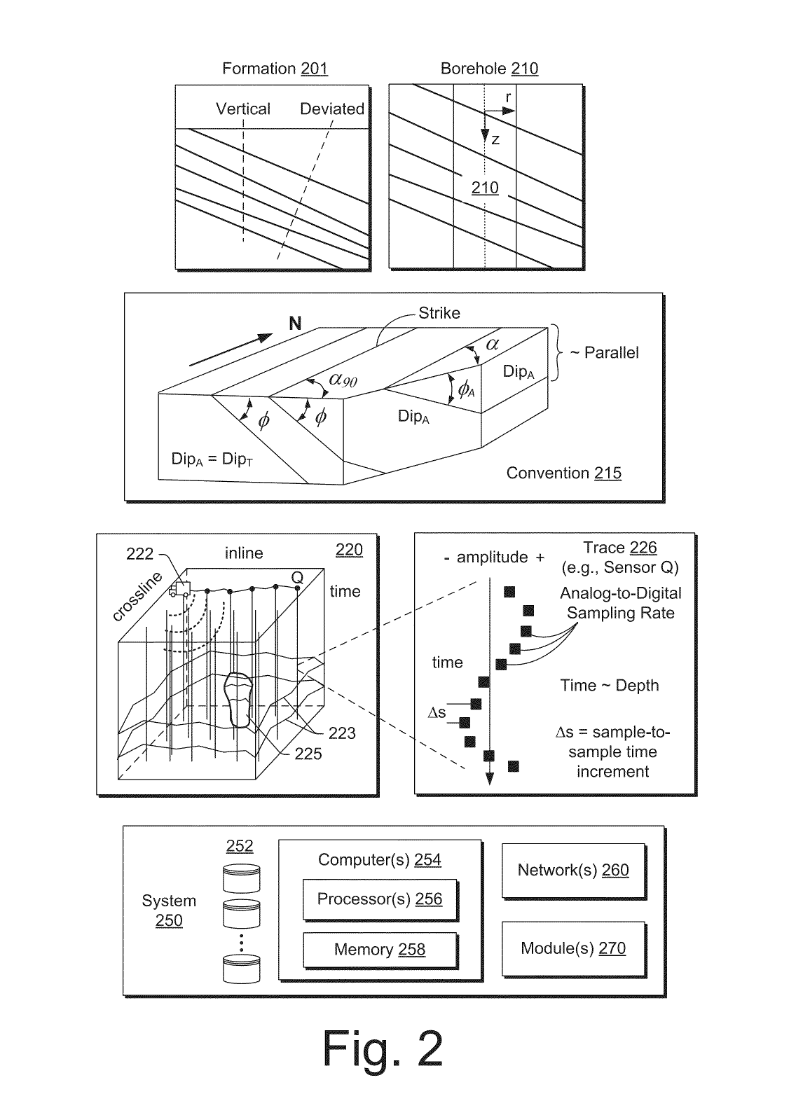

FIG. 2 shows an example of a formation 201, an example of a borehole 210, an example of a convention 215 for dip, an example of a data acquisition process 220, and an example of a system 250.

As shown, the formation 201 includes a horizontal surface and various subsurface layers. As an example, a borehole may be vertical. As another example, a borehole may be deviated. In the example of FIG. 2, the borehole 210 may be considered a vertical borehole, for example, where the z-axis extends downwardly normal to the horizontal surface of the formation 201.

As to the convention 215 for dip, as shown, the three dimensional orientation of a plane can be defined by its dip and strike. Dip is the angle of slope of a plane from a horizontal plane (e.g., an imaginary plane) measured in a vertical plane in a specific direction. Dip may be defined by magnitude (e.g., also known as angle or amount) and azimuth (e.g., also known as direction). As shown in the convention 215 of FIG. 2, various angles indicate angle of slope downwards, for example, from an imaginary horizontal plane (e.g., flat upper surface); whereas, azimuth refers to the direction towards which a dipping plane slopes (e.g., which may be given with respect to degrees, compass directions, etc.). Another feature shown in the convention of FIG. 2 is strike, which is the orientation of the line created by the intersection of a dipping plane and a horizontal plane (e.g., consider the flat upper surface as being an imaginary horizontal plane).

Some additional terms related to dip and strike may apply to an analysis, for example, depending on circumstances, orientation of collected data, etc. One term is “true dip” (see, e.g., Dip_{T} in the convention 215 of FIG. 2). True dip is the dip of a plane measured directly perpendicular to strike (see, e.g., line directed northwardly and labeled “strike” and angle α₉₀) and also the maximum possible value of dip magnitude. Another term is “apparent dip” (see, e.g., Dip_{A} in the convention 215 of FIG. 2). Apparent dip may be the dip of a plane as measured in any other direction except in the direction of true dip (see, e.g., φ_{A} as Dip_{A} for angle α); however, it is possible that the apparent dip is equal to the true dip (see, e.g., φ as Dip_{A}=Dip_{T} for angle α₉₀ with respect to the strike). In other words, where the term apparent dip is used (e.g., in a method, analysis, algorithm, etc.), for a particular dipping plane, a value for “apparent dip” may be equivalent to the true dip of that particular dipping plane.

As shown in the convention 215 of FIG. 2, the dip of a plane as seen in a cross-section exactly perpendicular to the strike is true dip (see, e.g., the surface with φ as Dip_{A}=Dip_{T} for angle α₉₀ with respect to the strike). As indicated, dip observed in a cross-section in any other direction is apparent dip (see, e.g., surfaces labeled Dip_{A}). Further, as shown in the convention 215 of FIG. 2, apparent dip may be approximately 0 degrees (e.g., parallel to a horizontal surface where an edge of a cutting plane runs along a strike direction).

In terms of observing dip in wellbores, true dip is observed in wells drilled vertically. In wells drilled in any other orientation (or deviation), the dips observed are apparent dips (e.g., which are referred to by some as relative dips). In order to determine true dip values for planes observed in such boreholes, as an example, a vector computation (e.g., based on the borehole deviation) may be applied to one or more apparent dip values.

As mentioned, another term that finds use in sedimentological interpretations from borehole images is “relative dip” (e.g., Dip_{R}). A value of true dip measured from borehole images in rocks deposited in very calm environments may be subtracted (e.g., using vector-subtraction) from dips in a sand body. The resulting dips from such a process are called relative dips and find use in interpreting sand body orientation.

A convention such as the convention 215 may be used with respect to an analysis, an interpretation, an attribute, etc. (see, e.g., various blocks of the system 100 of FIG. 1). As an example, various types of features may be described, in part, by dip (e.g., sedimentary bedding, faults and fractures, cuestas, igneous dikes and sills, metamorphic foliation, etc.).

Seismic interpretation may aim to identify and classify one or more subsurface boundaries based at least in part on one or more dip parameters (e.g., angle or magnitude, azimuth, etc.) and/or, for example, one or more other parameters. As an example, various types of features (e.g., sedimentary bedding, faults and fractures, cuestas, igneous dikes and sills, metamorphic foliation, etc.) may be described at least in part by angle, at least in part by azimuth, etc.

As shown in the diagram 220 of FIG. 2, a geobody 225 may be present in a geologic environment. For example, the geobody 225 may be a salt dome. A salt dome may be a mushroom-shaped or plug-shaped diapir made of salt and may have an overlying cap rock. Salt domes can form as a consequence of the relative buoyancy of salt when buried beneath other types of sediment. Hydrocarbons may be found at or near a salt dome due to formation of traps due to salt movement in association evaporite mineral sealing. Buoyancy differentials can cause salt to begin to flow vertically (e.g., as a salt pillow), which may cause faulting. In the diagram 220, the geobody 225 is met by layers which may each be defined by a dip angle φ. As an example, in a sedimentary basin, various layers may exist that may include properties that differ such that they may be identified as zones.

As an example, seismic data may be acquired for a region in the form of traces. In the example of FIG. 2, the diagram 220 shows acquisition equipment 222 emitting energy from a source (e.g., a transmitter) and receiving reflected energy via one or more sensors (e.g., receivers) strung along an inline direction. As the region includes layers 223 and, for example, the geobody 225, energy emitted by a transmitter of the acquisition equipment 222 can reflect off the layers 223 and the geobody 225. Evidence of such reflections may be found in the acquired traces. As to the portion of a trace 226, energy received may be discretized by an analog-to-digital converter that operates at a sampling rate. For example, the acquisition equipment 222 may convert energy signals sensed by sensor Q to digital samples at a rate of one sample per approximately 4 ms. Given a speed of sound in a medium or media, a sample rate may be converted to an approximate distance. For example, the speed of sound in rock may be on the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, the deepest boundary depth may be estimated to be about 10 km (e.g., assuming a speed of sound of about 5 km per second).

In the example of FIG. 2, the system 250 includes one or more information storage devices 252, one or more computers 254, one or more networks 260 and one or more modules 270. As to the one or more computers 254, each computer may include one or more processors (e.g., or processing cores) 256 and memory 258 for storing instructions (e.g., modules), for example, executable by at least one of the one or more processors. As an example, a computer may include one or more network interfaces (e.g., wired or wireless), one or more graphics cards, a display interface (e.g., wired or wireless), etc.

In the example of FIG. 2, the one or more memory storage devices 252 may store seismic data for a geologic environment that spans kilometers in length and width and, for example, around 10 km in depth. Seismic data may be acquired with reference to a surface grid (e.g., defined with respect to inline and crossline directions). For example, given grid blocks of about 40 meters by about 40 meters, a 40 km by 40 km field may include about one million traces. Such traces may be considered 3D seismic data where time approximates depth. As an example, a computer may include a network interface for accessing seismic data stored in one or more of the storage devices 252 via a network. In turn, the computer may process the accessed seismic data via instructions, which may be in the form of one or more modules.

As an example, one or more attribute modules may be provided for processing seismic data. As an example, attributes may include geometrical attributes (e.g., dip angle, azimuth, continuity, seismic trace, etc.). Such attributes may be part of a structural attributes library (see, e.g., the attribute component 130 of FIG. 1). Structural attributes may assist with edge detection, local orientation and dip of seismic reflectors, continuity of seismic events (e.g., parallel to estimated bedding orientation), etc. As an example, an edge may be defined as a discontinuity in horizontal amplitude continuity within seismic data and correspond to a fault, a fracture, etc. Geometrical attributes may be spatial attributes and rely on multiple traces.

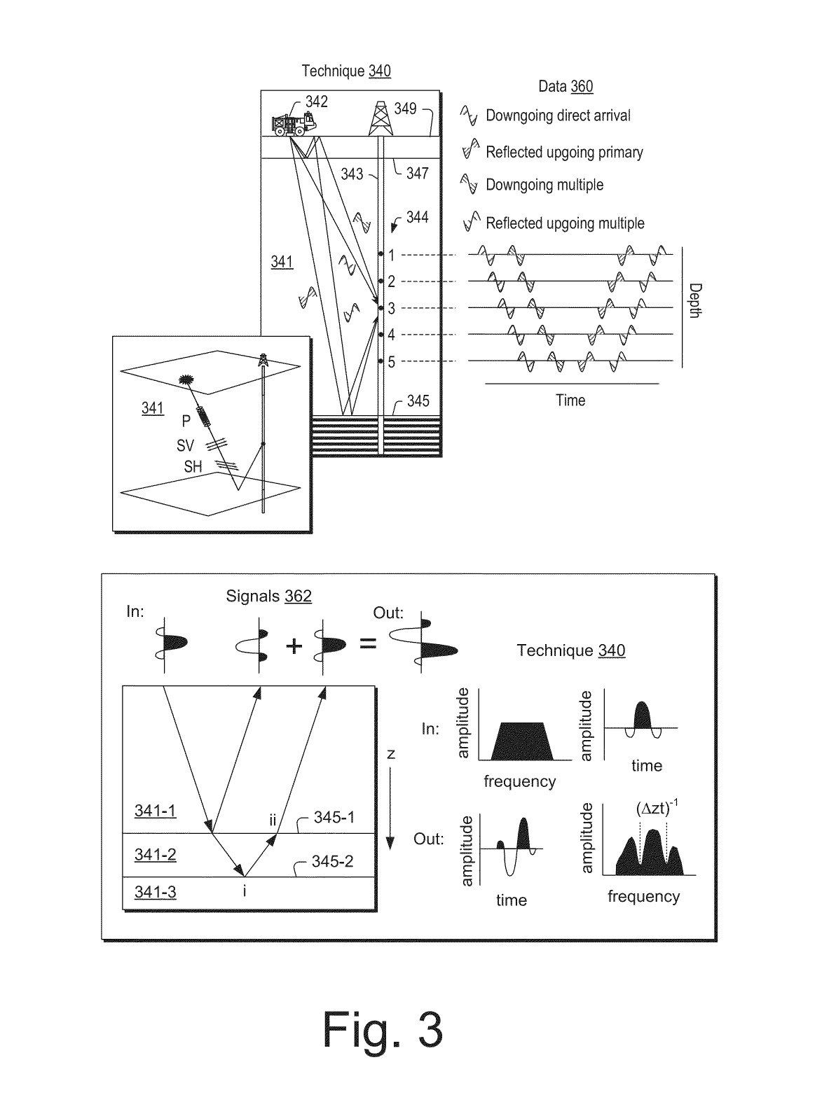

FIG. 3 shows an example of a technique 340 and an example of data 360 that includes (e.g., represents) signals 362. As shown, the technique 340 may be implemented with respect to a geologic environment 341. As shown, an energy source (e.g., a transmitter) 342 may emit energy where the energy travels as waves that interact with the geologic environment 341. As an example, the geologic environment 341 may include a bore 343 where one or more sensors (e.g., receivers) 344 may be positioned in the bore 343. As an example, energy emitted by the energy source 342 may interact with a layer (e.g., a structure, an interface, etc.) 345 in the geologic environment 341 such that a portion of the energy is reflected, which may then be sensed by one or more of the sensors 344. Such energy may be reflected as an upgoing primary wave (e.g., or “primary” or “singly” reflected wave). As an example, a portion of emitted energy may be reflected by more than one structure in the geologic environment and referred to as a multiple reflected wave (e.g., or “multiple”). For example, the geologic environment 341 is shown as including a layer 347 that resides below a surface layer 349. Given such an environment and arrangement of the source 342 and the one or more sensors 344, energy may be sensed as being associated with particular types of waves.

As an example, a “multiple” may refer to multiply reflected seismic energy or, for example, an event in seismic data that has incurred more than one reflection in its travel path. As an example, depending on a time delay from a primary event with which a multiple may be associated, a multiple may be characterized as a short-path or a peg-leg, for example, which may imply that a multiple may interfere with a primary reflection, or long-path, for example, where a multiple may appear as a separate event. As an example, seismic data may include evidence of an interbed multiple from bed interfaces, evidence of a multiple from a water interface (e.g., an interface of a base of water and rock or sediment beneath it) or evidence of a multiple from an air-water interface, etc.

As shown in FIG. 3, acquired data 360 can include data associated with downgoing direct arrival (DDA) waves, reflected upgoing primary (RUP) waves, downgoing multiple reflected (DMR) waves and reflected upgoing multiple reflected (RUMR) waves. The acquired data 360 is also shown along a time axis and a depth axis. As indicated, in a manner dependent at least in part on characteristics of media in the geologic environment 341, waves travel at velocities over distances such that relationships may exist between time and space. Thus, time information, as associated with sensed energy, may allow for understanding spatial relations of layers, interfaces, structures, etc., in a geologic environment.

FIG. 3 also shows various types of waves as including P, SV an SH waves (see, e.g., three-dimensional representation of the geologic environment 341). As an example, a P-wave may be an elastic body wave or sound wave in which particles oscillate in the direction the wave propagates. As an example, P-waves incident on an interface (e.g., at other than normal incidence, etc.) may produce reflected and transmitted S-waves (e.g., “converted” waves). As an example, an S-wave or shear wave may be an elastic body wave, for example, in which particles oscillate perpendicular to the direction in which the wave propagates. S-waves may be generated by a seismic energy sources (e.g., other than an air gun). As an example, S-waves may be converted to P-waves. S-waves tend to travel more slowly than P-waves and do not travel through fluids that do not support shear. In general, recording of S-waves involves use of one or more receivers operatively coupled to earth (e.g., capable of receiving shear forces with respect to time). As an example, interpretation of S-waves may allow for determination of rock properties such as fracture density and orientation, Poisson's ratio and rock type, for example, by crossplotting P-wave and S-wave velocities, and/or by other techniques.

As an example of parameters that may characterize anisotropy of media (e.g., seismic anisotropy), consider the Thomsen parameters ε, δ and γ. The Thomsen parameter δ describes depth mismatch between logs (e.g., actual depth) and seismic depth. As to the Thomsen parameter ε, it describes a difference between vertical and horizontal compressional waves (e.g., P or P-wave or quasi compressional wave qP or qP-wave). As to the Thomsen parameter γ, it describes a difference between horizontally polarized and vertically polarized shear waves (e.g., horizontal shear wave SH or SH-wave and vertical shear wave SV or SV-wave or quasi vertical shear wave qSV or qSV-wave). Thus, the Thomsen parameters ε and γ may be estimated from wave data while estimation of the Thomsen parameter δ may involve access to additional information.

In FIG. 3, the technique 340 may be implemented to acquire the signals 362. As an example, the technique 340 may include emitting energy with respect to time where the energy may be represented in a frequency domain, for example, as a band of frequencies. In such an example, the emitted energy may be a wavelet and, for example, referred to as a source wavelet which has a corresponding frequency spectrum (e.g., per a Fourier transform of the wavelet).

As an example, the geologic environment 341 may include layers 341-1, 341-2 and 341-3 where an interface 345-1 exists between the layers 341-1 and 341-2 and where an interface 345-2 exists between the layers 341-2 and 341-3. As illustrated in FIG. 3, a wavelet may be first transmitted downward in the layer 341-1; be, in part, reflected upward by the interface 345-1 and transmitted upward in the layer 341-1; be, in part, transmitted through the interface 345-1 and transmitted downward in the layer 341-2; be, in part, reflected upward by the interface 345-2 (see, e.g., “i”) and transmitted upward in the layer 341-2; and be, in part, transmitted through the interface 345-1 (see, e.g., “ii”) and again transmitted in the layer 341-1. In such an example, signals (see, e.g., the signals 362) may be received as a result of wavelet reflection from the interface 345-1 and as a result of wavelet reflection from the interface 345-2. These signals may be shifted in time and in polarity such that addition of these signals results in a waveform that may be analyzed to derive some information as to one or more characteristics of the layer 341-2 (e.g., and/or one or more of the interfaces 345-1 and 345-2). For example, a Fourier transform of signals may provide information in a frequency domain that can be used to estimate a temporal thickness (e.g., Δzt) of the layer 341-2 (e.g., as related to acoustic impedance, reflectivity, etc.).

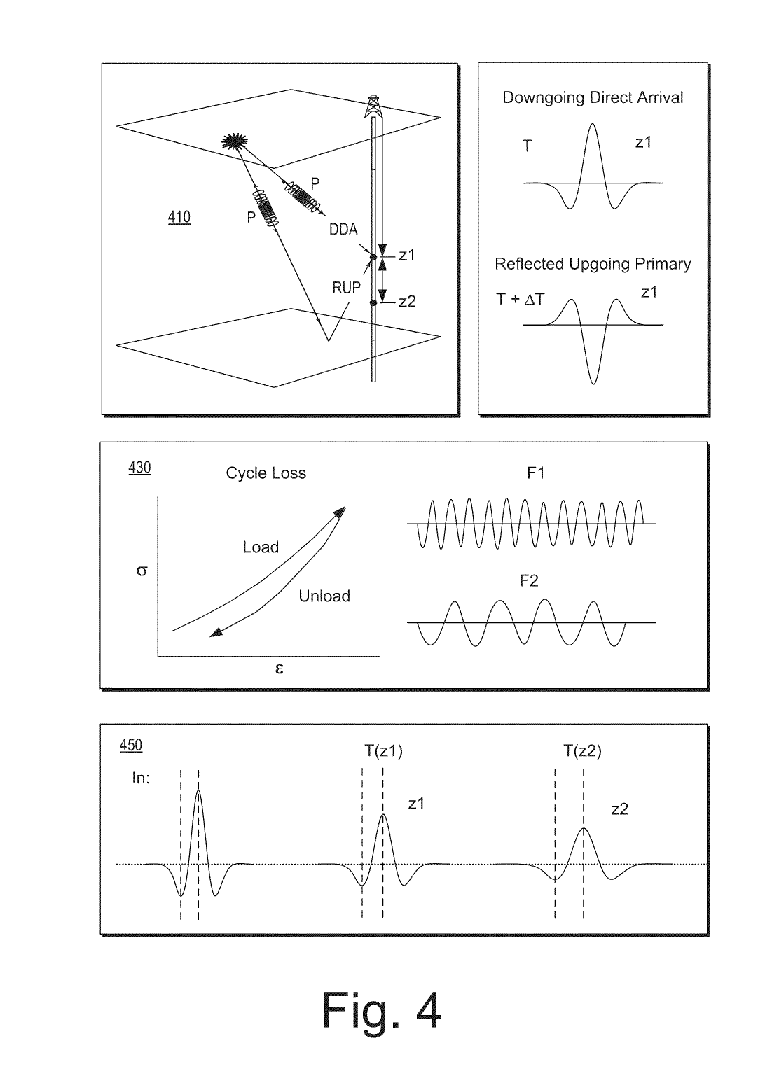

FIG. 4 shows an example of a geologic environment 410 that includes a bore with one or more receivers (e.g., sensors) at positions z1 and z2. Examples of wavelets are also shown corresponding to a downgoing direct arrival (DDA) and a reflected upgoing primary (RUP). As an example, a method may include acquiring data that includes information as to first downgoing-P arrivals (e.g., P-waves) at various positions (e.g., depths, etc.) and analyzing the data, for example, as to stretch with respect to position. As an example, stretch may be determined by analyzing a trough and a peak in data. For example, consider analyzing downgoing direct arrivals by determining a distance (e.g., time-wise, depth-wise, etc.) between a trough and a peak.

As illustrated with respect to plots 430, oscillating energy (e.g., elastic waves) may experience “cycle loss” as it travels in a medium or media. For example, oscillating energy may interact with material via loading and unloading. In such a process, mechanical energy may be progressively converted to heat. For example, through friction, viscosity, etc., interactions with respect to grain boundaries, pores, cracks, water, gas, etc., may act to convert mechanical energy to heat energy. Such processes can cause the amplitude of an elastic wave to decrease and cause its wavelength to broaden. As shown, an elastic wave at a frequency F1 when compared to an elastic wave at a lower frequency F2 will experience more cycles over time (e.g., or distance). Thus, a higher frequency elastic wave may experience cycle loss differently than a lower frequency elastic wave (e.g., due to a higher number of cycles per unit time or unit distance for the higher frequency elastic wave).

As an example, attenuation of energy may be characterized at least in part by a quality factor, Q-factor. A Q-factor may be associated with material and it may depend at least in part on frequency. As an example, a Q-factor may be a measure of relative energy loss per oscillation cycle of a wave as it travels in material. As an example, a Q-factor may be about 30 for weathered sedimentary rocks and a Q-factor may be about 1000 for granite. As an example, a Q-factor may be dependent on physical state of rock (e.g., for sandstone, consider clay content and porosity).

FIG. 4 shows a plot 450 of a series of wavelets, which may be, for example, downgoing direct arrivals (DDAs) at different positions in a bore such as the positions z1 and z2 of the bore of the geologic environment 410. As illustrated in the plot 450, the input wavelet decreases in amplitude and broadens as it progresses through the geologic environment 410 where at the position z2, the wavelet is of lesser amplitude and broader than at the position z1. As an example, a method may characterize a difference between these wavelets by a stretch parameter, which may be, for example, measured between a trough and a peak. In such an example, the stretch parameter pertains to broadening. As an example, one or more other parameters may be determined. For example, consider an amplitude parameter that may characterize a difference in amplitude for wavelets.

As an example, various types of surveys may include acquiring data that can include downgoing direct arrivals (DDAs). For example, a vertical seismic profile (VSP) survey may include acquiring data that include downgoing direct arrivals (DDAs), which may considered (e.g., on a receiver-by-receiver basis, etc.), first arrivals.

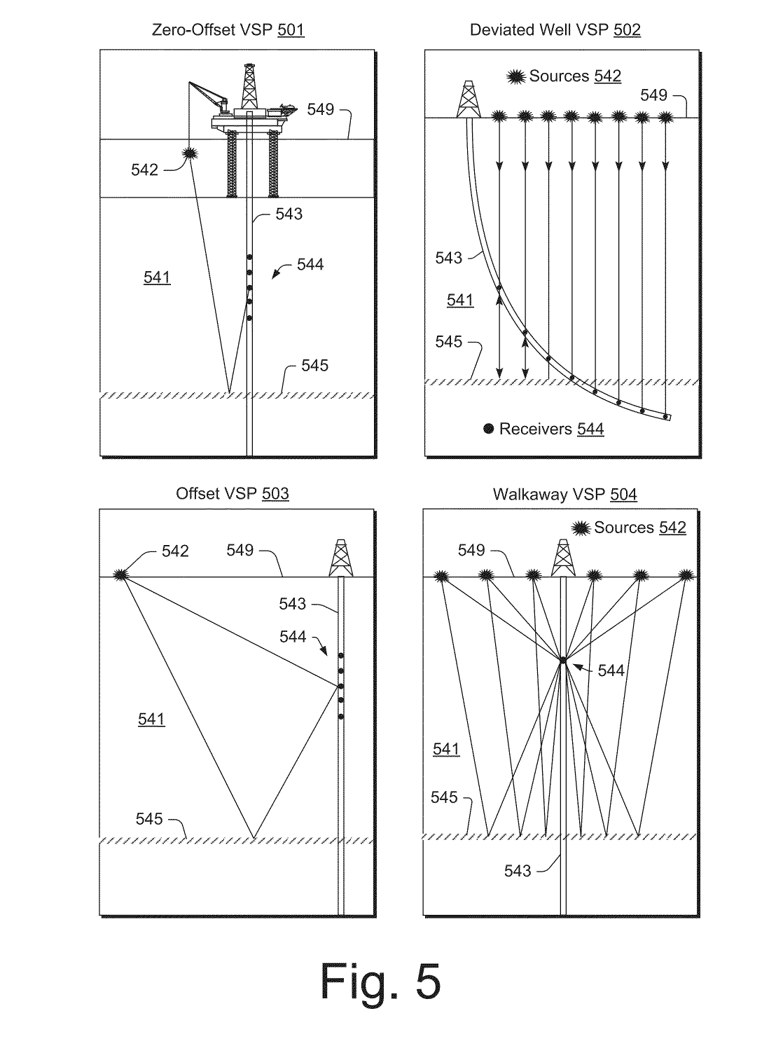

FIG. 5 shows some examples of data acquisition techniques or “surveys” that include a zero-offset vertical seismic profile (VSP) technique 501, a deviated well vertical seismic profile technique 502, an offset vertical seismic profile technique 503 and a walkaway vertical seismic profile technique 504. In each of the examples, a geologic environment 541 with a surface 549 is shown along with at least one energy source (e.g., a transmitter) 542 that may emit energy where the energy travels as waves that interact with the geologic environment 541. As an example, the geologic environment 541 may include a bore 543 where one or more sensors (e.g., receivers) 544 may be positioned in the bore 543. As an example, energy emitted by the energy source 542 may interact with a layer (e.g., a structure, an interface, etc.) 545 in the geologic environment 541 such that a portion of the energy is reflected, which may then be sensed by at least one of the one or more of the sensors 544. Such energy may be reflected as an upgoing primary wave (e.g., or “primary” or “singly” reflected wave). As an example, a portion of emitted energy may be reflected by more than one structure in the geologic environment and referred to as a multiple reflected wave. As an example, a multiple reflected wave may be or include an interbed multiple reflected wave.

As to the example techniques 501, 502, 503 and 504, these are described briefly below, for example, with some comparisons. As to the technique 501, given the acquisition geometry, with no substantial offset between the source 542 and bore 543, a zero-offset VSP may be acquired. In such an example, seismic waves travel substantially vertically down to a reflector (e.g., the layer 545) and up to the receiver 544, which may be a receiver array. As to the technique 502, this may be another so-called normal-incidence or vertical-incidence technique where a VSP may be acquired in, for example, a deviated bore 543 with one or more of the source 542 positioned substantially vertically above individual receivers 544 (e.g., individual receiver shuttles). The technique 502 may be referred to as a deviated-well or a walkabove VSP. As to the offset VSP technique 503, in the example of FIG. 5, an array of seismic receivers 544 may be clamped in a bore 543 and a seismic source 542 may be placed a distance away. In such an example, non-vertical incidence can give rise to P- to S-wave conversion. As to the walkaway VSP technique 504, as an example, a seismic source 542 may be activated at numerous positions along a line on the surface 349. The techniques 501, 502, 503 and 504 may be implemented as onshore and/or offshore surveys.

As may be appreciated from the examples of FIG. 5, a borehole seismic survey may be categorized by a survey geometry, which may be determined by source offset, borehole trajectory and receiver array depth. For example, a survey geometry may determine dip range of interfaces and the subsurface volume that may be imaged. As an example, a survey may define a region, for example, a region about a borehole (e.g., via one or more dimensions that may be defined with respect to the borehole). As an example, positions of equipment may define, at least in part, a survey geometry (e.g., and a region associated with a borehole, wellbore, etc.).

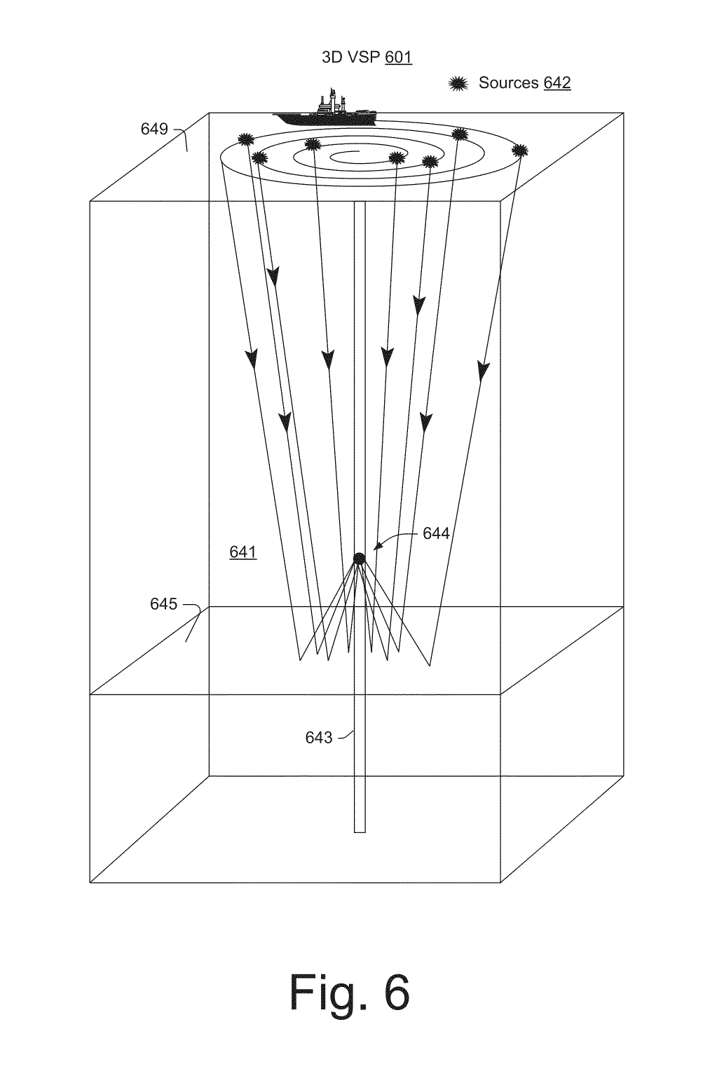

The example techniques 501, 502, 503 and 504 of FIG. 5 may be applied, for example, to provide information and/or images in one or two dimensions (e.g., or optionally three-dimensions, depending on implementation). As to three-dimensional VSPs, FIG. 6 shows an example of a technique 601 with respect to a geologic environment 641, a surface 649, at least one energy source (e.g., a transmitter) 642 that may emit energy where the energy travels as waves that interact with the geologic environment 641. As an example, the geologic environment 641 may include a bore 643 where one or more sensors (e.g., receivers) 644 may be positioned in the bore 643. As an example, energy emitted by the energy source 642 may interact with a layer (e.g., a structure, an interface, etc.) 645 in the geologic environment 641 such that a portion of the energy is reflected, which may then be sensed by at least one of the one or more of the sensors 644.

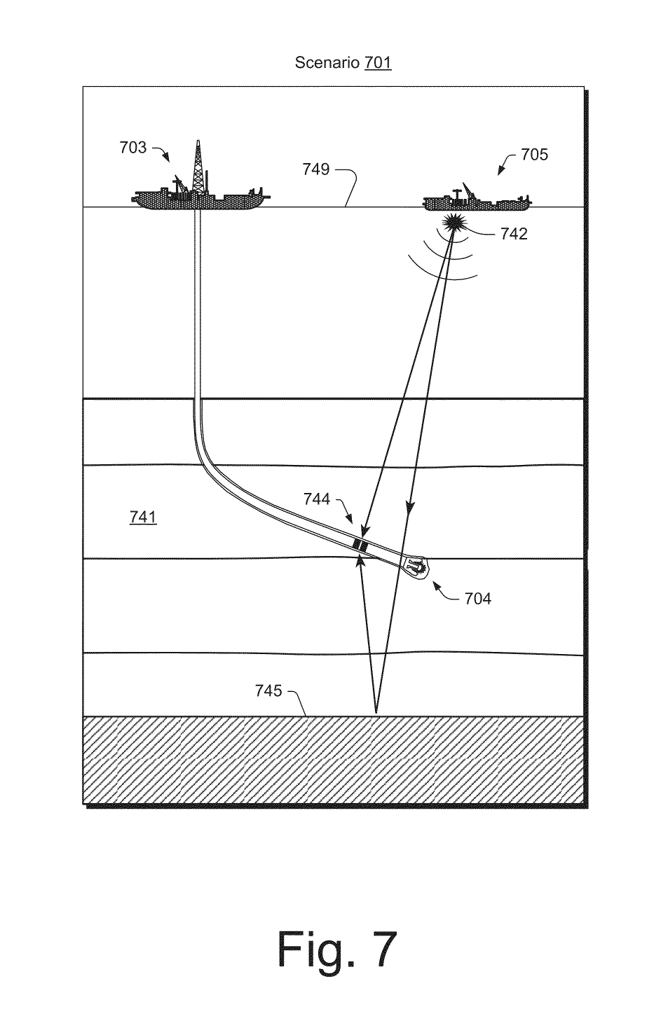

As an example, a method may include receiving data, for example, as acquired using one or more survey techniques such as, for example, one or more of the survey techniques of FIG. 5 and/or FIG. 6. As an example, data may include data acquired using a seismic-while-drilling (SWD) technique. For example, FIG. 7 shows a scenario 701 where drilling equipment 703 operates a drill bit 704 operatively coupled to an equipment string that includes one or more sensors (e.g., one or more receivers) 744. In the scenario 701, the drill bit 704 is advanced in a geologic environment 741 that includes stratified layers disposed below a sea bed surface where the layers include a layer 745. As shown in the example of FIG. 7, at a water surface 749 of the geologic environment 741, seismic equipment 705 includes a seismic energy source 742 that can emit seismic energy into the geologic environment 741.

As an example, the seismic equipment 705 may be moveable, duplicated, etc., for example, to emit seismic energy from various positions, which may be positions about a region of the geologic environment 741 that includes the drill bit 704. As an example, the scenario 701 may be a VSP scenario, for example, where the equipment 703, 744, 705 and 742 can perform a seismic survey (e.g., a VSP while drilling survey).

As an example, a survey may take place during one or more so-called “quiet” periods during which drilling is paused. As an example, data acquired via a survey may be analyzed where results from an analysis or analyses may be used, at least in part, to direct further drilling, make assessments as to a drilled portion of a geologic environment, etc. As an example, a method may optionally include processing in near real-time, which may, for example, be instructive for seismic while drilling, etc.

As an example, a 3D VSP technique may be implemented with respect to an onshore and/or an offshore environment. As an example, an acquisition technique for an onshore (e.g., land-based) survey may include positioning a source or sources along a line or lines of a grid; whereas, in an offshore implementation, source positions may be laid out in lines or in a spiral centered near a well.

A 3D acquisition technique may help to illuminate one or more 3D structures (e.g., one or more features in a geologic environment). Information acquired from a 3D VSP may assist with exploration and development, pre-job modeling and planning, etc. As an example, a 3D VSP may fill in one or more regions that lack surface seismic survey information, for example, due to interfering surface infrastructure or difficult subsurface conditions, such as, for example, shallow gas, which may disrupt propagation of P-waves (e.g., seismic energy traveling through fluid may exhibit signal characteristics that differ from those of seismic energy traveling through rock).

As an example, a VSP may find use to tie time-based surface seismic images to one or more depth-based well logs. For example, in an exploration area, a nearest well may be quite distant such that a VSP is not available for calibration before drilling begins on a new well. Without accurate time-depth correlation, depth estimates derived from surface seismic images may include some uncertainties, which may, for example, add risk and cost (e.g., as to contingency planning for drilling programs). As an example, a so-called intermediate VSP may be performed, for example, to help develop a time-depth correlation. For example, an intermediate VSP may include running a wireline VSP before reaching a total depth. Such a survey may, for example, provide for a relatively reliable time-depth conversion; however, it may also add cost and inefficiency to a drilling operation and, for example, it may come too late to forecast drilling trouble. As an example, a seismic while drilling process may be implemented, for example, to help reduce uncertainty in time-depth correlation without having to stop a drilling process. Such an approach may provide real-time seismic waveforms that can allow an operator to look ahead of a drill bit, for example, to help guide a drill string to a target total depth.

As an example, a data acquisition technique may be implemented to help understand a fracture, fractures, a fracture network, etc. As an example, a fracture may be a natural fracture, a hydraulic fracture, a fracture stemming from production, etc. As an example, seismic data may help to characterize direction and magnitude of anisotropy that may arise from aligned natural fractures. As an example, a survey may include use of offset source locations that may span, for example, a circular arc to probe a formation (e.g., from a wide range of azimuths). As an example, a hydraulically induced fracture or fractures may be monitored using one or more borehole seismic methods. For example, while a fracture is being created in a treatment well, a multicomponent receiver array in a monitor well may be used to record microseismic activity generated by a fracturing process.

Seismic surveys may be acquired at different stages in the life of a reservoir. As an example, one or more of offset VSPs, walkaway VSPs, 3D VSPs, etc., may be acquired in time-lapse fashion, for example, before and after production. Time-lapse surveys may reveal changes in position of fluid contacts, changes in fluid content, and other variations, such as pore pressure, stress and temperature. VSP techniques may be seen as evolving, for example, from being a time-depth tie for surface seismic data to being capable of encompassing a range of solutions to various types of questions germane to exploration, production, etc.

As an example, VSP processing may create wavefields that may be expressed in terms of different time coordinates, or time frames. VSP survey arrival times for downgoing arrivals tends to increase with respect to receiver depth while upgoing reflection times from a subsurface horizon tend to decrease with respect to increasing receiver depth (e.g., where a receiver is closer to a reflector). Thus, slopes for arrival times of downgoing and upgoing arrivals can have different signs.

As to VSP data processing, as an example, in field record time (FRT), downgoing compressional events have opposite time-dip from upgoing events. For example, consider TT to be a first-arrival traveltime for downgoing arrivals. In such an example, a time frame advanced by first-arrival time by subtracting time TT, would flatten a downgoing wave and steepen a slope of upgoing events, for example, possibly causing aliasing of upgoing energy. As an example, a time frame delayed by first-arrival time (CTT) may flatten upgoing events for zero source-to-receiver lateral offset and, for example, horizontal reflectors. As an example, a time shift may effectively place an upgoing compressional event in a two-way time frame, for example, comparable with common midpoint (CMP) data.

As an example, corridor stacking may be performed in a CTT time frame. In such a domain, corridor stacking may involve summation of upgoing reflection energy along a line, for example, a line of constant time. Such VSP processing may involve separation of upgoing wavefields and downgoing wavefields. For example, during processing, first-arrival times may be subtracted from a downgoing wavefield in a CTT time frame (e.g., CTT domain). In such an example, application of f-k filtering (e.g., frequency-wavenumber filtering) may separate out an upgoing reflected wavefield and leave a downgoing wavefield. As an example, median filtering may be applied to enhance signal-to-noise ratio. As an example, waveshaping a downgoing wavelet may produce a deconvolved downgoing wavefield.

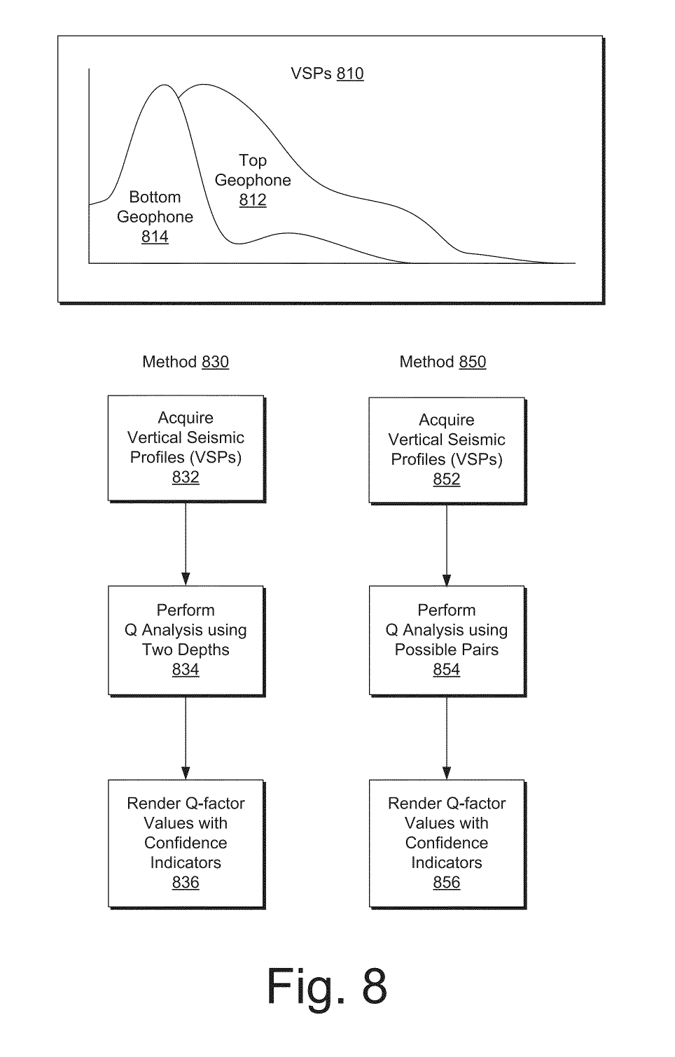

FIG. 8 shows examples of methods 830 and 850 that include acquisition of vertical seismic profiles (VSPs), for example, as indicated in a plot 810 that illustrates an approximation of data for a top geophone VSP 812 and data for a bottom geophone VSP 814 (e.g., spectra between deepest and shallowest VSP geophones).

As an example, a Q-factor may be defined as a measure of anelastic attenuation of seismic waves. As mentioned, a Q-factor can have an effect on phase, amplitude and resolution of a seismic signal. As an example, a high Q-factor value may indicate minimal attenuation (e.g., consider granite) whereas a low Q-factor value (e.g., consider weathered sedimentary rocks) may indicate considerable attenuation. As an example, an inverse Q-factor filter may be implemented in an effort to increase bandwidth and correct amplitudes of borehole data and surface seismic data. As an example, a Q-factor may be measured using a VSP downgoing wavefield, for example, where a seismic wavefield is sampled by geophones in a borehole as the wavefield travels down through the Earth. As an example, spectral ratios may be calculated between receiver pairs in a VSP, which may, in turn, be used to determine Q-factor values, for example, with respect to depth. As an example, confidence values may be assigned or determined for such Q-factor values (e.g., per confidence in spectral slope, etc.).

As an example, a deterministic Q-factor value estimation may be performed using spectral ratio, for example, by comparing the decay of high frequencies between the shallowest and the deepest VSP level (e.g., using 2 depth levels such as shown in the plot 810). As an example, another approach, referred to as a multi-spectral ratio may use possible pairs of recorded VSP levels to improve the statistical significance of Q-factor estimates. As an example, for various types of estimation processes, resulting Q-factor estimates may be confidence coded (e.g., using a color or other scheme) based on inverse slope standard deviation (e.g., consider a color coding scheme with smaller confidence values being blue and larger confidence values being yellow-red).

As shown in FIG. 8, the method 830 includes acquiring VSPs 832, performing a Q-factor analysis using two depths (e.g., top and bottom) 834 and rendering Q-factor values (e.g., estimates) with confidence indicators 836. As shown in FIG. 8, the method 850 includes acquiring VSPs 852, performing a Q-factor analysis using possible pairs (e.g., available pairs) 854 and rendering Q-factor values (e.g., estimates) with confidence indicators 856.

As an example, in a spectral ratio approach, a plot of traces with respect to cable length (e.g., in meters) and time minus transit time (e.g., in seconds) may provide a “shape” of a first arrival that changes with depth (e.g., lowering of high frequency). Such an approach may be viewed as a data set aligned to transit time picking. As an example, a two frequency spectrum of two traces may be rendered (e.g., displayed), which may show a high frequency decrease on deepest trace and a spectral ratio between the two traces may be rendered to indicate a Q-factor estimate as a slope with an associated confidence indicator (e.g., a ratio versus increasing frequency plot where a downward slope may be given as a positive Q-factor value).

As an example, in a multi-spectral ratio approach, estimated Q-factor values may be plotted versus cable length (e.g., depth). Such a plot may provide indicators as to confidence in the estimates to identify a best estimate or range of estimates for purposes of further evaluations, calculations, etc. As an example, for trial data, where the two VSP approach yields a Q-factor value of about 66, the multi-spectral approach yields a Q-factor range of about 52 to about 68 using confidence as a criterion (e.g., over a mid-cable length).

As an example, another approach may be referred to as a continuous Q-factor analysis using spectral ratio. Such an approach can use a trace reference at a shallowest section and then calculate available pair levels based on that same reference trace. In such an approach, variation with depth of the Q-factor can then delimit an interval of Q-factor values. Such an approach may reveal “zones,” for example, Zone X up to 3200 m and Zone Y from 3200 m up to a total depth “TD”). For example, a plot of Q-factor values versus cable length may demarcate a visual change in slope, which may be indicia of a change in “zone” within a borehole.

In the aforementioned continuous Q-factor analysis using spectral ratio, for example, based on a correlation coefficient, it may be possible to determine the minimum delta time between two levels transit time (e.g., which may be effective to estimate a Q-factor). In such an approach, below this delta transit time, the results may be more subject to error. For example, in trial data, if the pair of levels result in a delta transit time less than about 200 ms, the result of Q-factor estimate is likely to be unreliable.

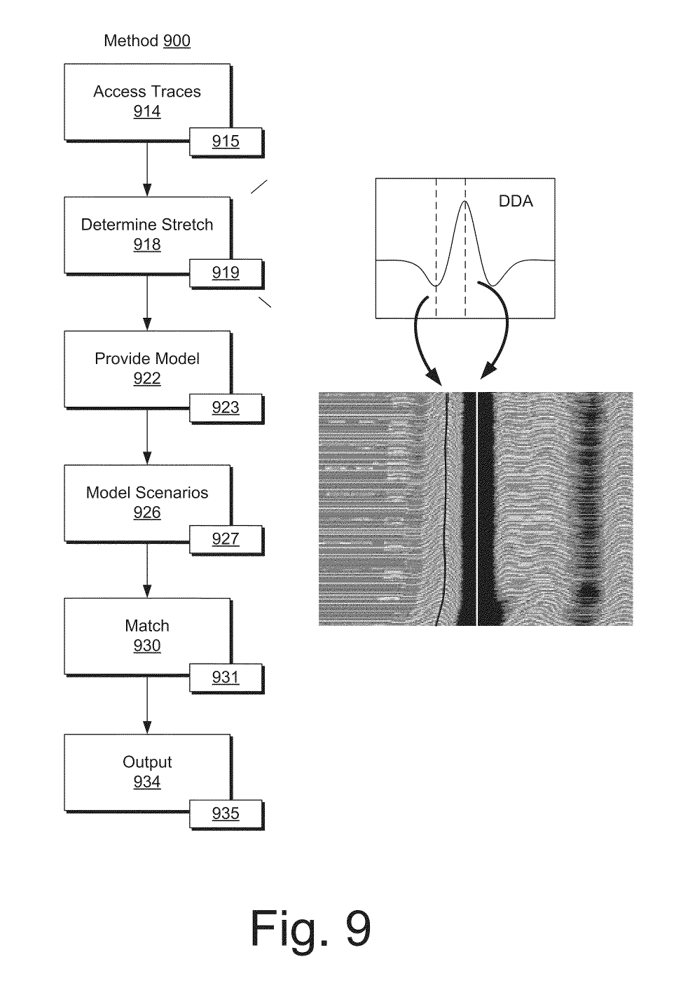

FIG. 9 shows an example of a method 900 that includes using a time domain. For example, such an approach can include using the “stretch” of a first downgoing-P arrival for Q-factor interval zone analysis. As an example, auto correlation of traces may be performed, for example, where an air gun may be used as the source; noting that use of a vibroseis or other technology may alleviate a need to auto correlate traces.

The method 900 includes an access block 914 for accessing traces and a determination block 918 for determining stretch using the accessed traces. For example, to determine stretch, a user, an algorithm, etc. may pick the first trough and the first peak of the first arrival. As an example, a wavelet is shown in a plot of amplitude versus wavelet length in time (e.g., seconds). A vertical line to the left passes through the minimum of a trough while a vertical line near center passes through a maximum of a peak. By repeating this process for wavelets in traces, a stack of traces may be plotted with respect to cable length and time minus transit time such that the peak times are aligned to produce a substantially vertical line while the trough times may be connected via a curve (e.g., or line segments, etc.) to indicate how they deviate or otherwise vary with respect to cable length and the peak times.

As an example, synthetic data may be generated for an ideal wavefield with a shallowest trace duplicated up to a total depth, for example, where the wavefield may be used to generate Q-charts. In such an example, using the ideal wavefield, a method may model the effect of Q-factor in a time domain, for example, using trough and peak where a delta time between trough and peak lines (e.g., or curves, etc.) may be saved for various Q-factors modeled. Referring again to the method 900, it includes a provision block 922 for providing a model and a modeling block 926 for modeling various scenarios. In such an example, per a match block 930, the method 900 can include matching between the model scenarios and the determined stretches for the accessed traces and, where an appropriate match is found, per an output block 934, the method 900 may output one or more Q-factor values (e.g., with respect to depth, etc.).

As an example, the match block 930 of the method 900 may be implemented in one or more manners, optionally iteratively, for example, in conjunction with the modeling block 926 (e.g., to generate iterative scenarios, etc.). As an example, a series of Q-charts may be generated, for example, for purposes of matching. As an example, Q-charts may be scenarios generated by simulations using a model. Such charts may be presented, for example, as one way time versus a time differential. In such an example, the one way time may be associated with depth (e.g., borehole depth) and a family of Q lines may be presented with respect to data, for example, for purposes of visual comparisons (e.g., to match a slope of data and Q-factor values shown as slopes with respect to the one way time (e.g., depth) and the time differential. For example, a family of Q-charts may be generated for a range of Q-factor values (e.g., Q=90, 100, 110, 120, etc.). Such an approach may assist with a visual analysis to hone in on more particular estimates (e.g., for a zone, for distinguishing zones, etc.). Where a zone in a multi-zone region is noted, another family of Q-charts may be generated for another range (e.g., overlapping with the first range or not). For example, where multiple zones are noted, another family of Q-charts may include Q-factor values of, for example, 65, 70, 75 and 80. Such a process may be repeated for each zone in a multiple zone region (e.g., consider yet another family of Q-charts with Q-factor values of, for example, 25, 30, 35 and 40). In such a manner, the method 900 may be implemented serially or in parallel where multiple zones appear to exist in a region (e.g., or are known to exist in a region). As an example, a method may include discretizing data based on stretch into multiple zones and then estimating a Q-factor value for each of the zones (e.g., optionally with one or more confidence or other statistical indicators).

The method 900 is shown in FIG. 9 in association with various computer-readable media (CRM) blocks 915, 919, 923, 927, 931 and 935. Such blocks generally include instructions suitable for execution by one or more processors (or processing cores) to instruct a computing device or system to perform one or more actions. While various blocks are shown, a single medium may be configured with instructions to allow for, at least in part, performance of various actions of the method 900. As an example, a computer-readable medium (CRM) may be a computer-readable storage medium. A CRM may be non-transitory while a computer-readable storage medium is non-transitory. As an example, one or more actions, blocks, etc. may be provided as a module, for example, such as one of the modules 270 of the system 250 of FIG. 2.

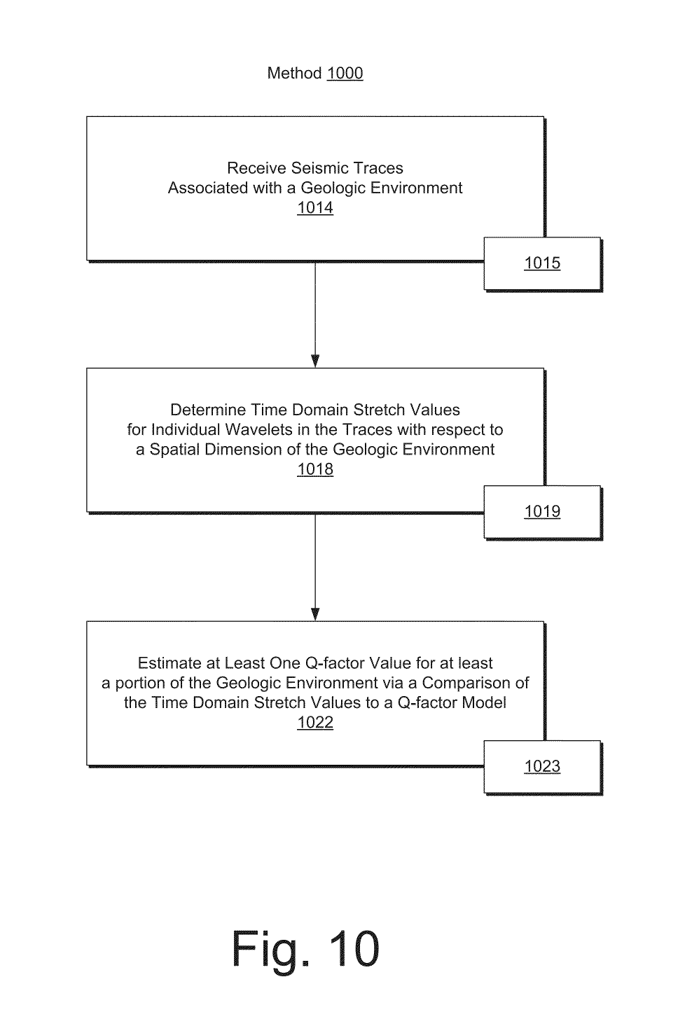

FIG. 10 shows an example of a method 1000 that includes a reception block 1014 for receiving seismic traces associated with a geologic environment, a determination block 1018 for determining time domain stretch values for individual wavelets in at least a portion of the seismic traces with respect to a spatial dimension of the geologic environment and an estimation block 1022 for estimating at least one Q-factor value for at least a portion of the geologic environment via a comparison of the time domain stretch values to a Q-factor model.

The method 1000 is shown in FIG. 10 in association with various computer-readable media (CRM) blocks 1015, 1019, and 1023. Such blocks generally include instructions suitable for execution by one or more processors (or processing cores) to instruct a computing device or system to perform one or more actions. While various blocks are shown, a single medium may be configured with instructions to allow for, at least in part, performance of various actions of the method 1000. As an example, a computer-readable medium (CRM) may be a computer-readable storage medium. A CRM may be non-transitory while a computer-readable storage medium is non-transitory. As an example, one or more actions, blocks, etc. may be provided as a module, for example, such as one of the modules 270 of the system 250 of FIG. 2.

As an example, a method may include receiving seismic traces where the seismic traces may have been acquired as part of a seismic survey. As an example, consider a vertical seismic profile (VSP) survey. As an example, individual wavelets of seismic traces may include individual downgoing direct arrival wavelets.

As an example, a time domain stretch value may be a time difference value between a trough of a wavelet and a peak of the wavelet. As an example, a time domain stretch value may be a time difference value between two points of a first downgoing P-wave arrival wavelet. As an example, a time domain stretch value may be a time difference between two critical points of a wavelet. In mathematics, a critical point (e.g., or stationary point) of a differentiable function of a real or complex variable is a value in its domain where its derivative is 0. For example, a minimum may be a critical point and a maximum may be a critical point. As an example, a trough may include a critical point and a peak may include a critical point. As an example, a method may include analyzing a trace to determine at least one critical point. As an example, a method may include analyzing a trace to determine two critical points and, for example, a value that represents a spacing between the two critical points (e.g., a time difference).

As an example, a method may include autocorrelating seismic traces. As an example, a method may include receiving autocorrelated seismic traces. As an example, a method may include receiving seismic traces that may include pneumatic energy source generated seismic traces (e.g., consider an airgun as an energy source). As an example, a method may include receiving seismic traces that may include vibroseis seismic traces.

In a vibroseis seismogram survey, a process may cross-correlate a sweep with an uncorrelated seismogram. In such an example, the process may collapse sweeps into wavelets and reduce length of a seismogram.

As an example, a method may include applying reverse Q-filtering to at least a portion of seismic traces using at least one estimated Q-factor value. As an example, where seismic traces may define zones and where a Q-factor value is estimated for one of the zones, a method may include reverse Q-filtering using the estimated Q-factor value.

As an example, a system can include a processor; memory accessibly by the processor; one or more modules storable in the memory where the one or more modules include processor-executable instructions to instruct the system to receive seismic traces associated with a geologic environment; determine time domain stretch values for individual wavelets in at least a portion of the seismic traces with respect to a spatial dimension of the geologic environment; and estimate at least one Q-factor value for at least a portion of the geologic environment via a comparison of the time domain stretch values to a Q-factor model. In such an example, the one or more modules may include processor-executable instructions to instruct the system to generate the Q-factor model, which may include, for example, model information for a plurality of Q-factor values.

As an example, one or more modules may include processor-executable instructions to instruct a system to perform reverse Q-filtering. As an example, one or more modules may include processor-executable instructions to instruct a system to acquire seismic traces.

As an example, one or more computer-readable storage media may include computer-executable instructions executable by a computer to instruct the computer to: receive seismic traces associated with a geologic environment; determine time domain stretch values for individual wavelets in at least a portion of the seismic traces with respect to a spatial dimension of the geologic environment; and estimate at least one Q-factor value for at least a portion of the geologic environment via a comparison of the time domain stretch values to a Q-factor model. In such an example, the one or more computer-readable storage media may include computer-executable instructions executable by a computer to instruct the computer to generate the Q-factor model, for example, where the Q-factor model includes model information for a plurality of Q-factor values. As an example, one or more computer-readable storage media may include computer-executable instructions executable by a computer to instruct the computer to perform reverse Q-filtering.

As an example, a model may include one or more charts that model energy attenuation with respect to depth in a geologic environment where each chart may represent energy attenuation for a particular Q-factor. As an example, a method may include generation of synthetic data that simulates a theoretical effect of a Q-factor value on a time domain stretch of a wavelet with respect to a spatial dimension such as depth. As an example, a chart may be a Q-factor chart and a model may include a plurality of Q-factor charts.

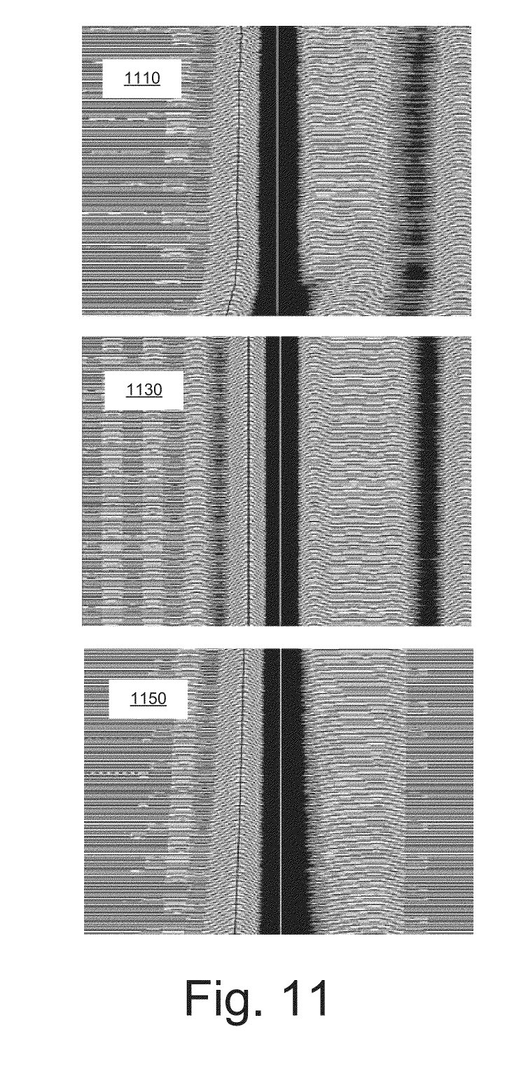

FIG. 11 shows an example plot 1110 of data (e.g., seismic traces), an example plot 1130 of model data with no attenuation and an example plot 1150 of model data with attenuation (e.g., time domain stretch). As an example, a method may include determining a time domain stretch value for a shallowest trace and then generating an ideal wavefield with the shallowest trace duplicated up to a particular depth. In such an example, the ideal wavefield may be mathematically stretched according to a particular Q-factor value to generate a model wavefield for that Q-factor value. For example, consider the plot 1150 as corresponding to a model wavefield for a particular Q-factor value. In such an example, the plot 1110 may be compared to the plot 1150 to determine whether a match exists for at least a portion of the plot 1110 to the plot 1150, particularly from the shallowest trace to a depth that may be less than the total depth. For example, a match may exist over a zone (e.g., a portion of a geologic environment).

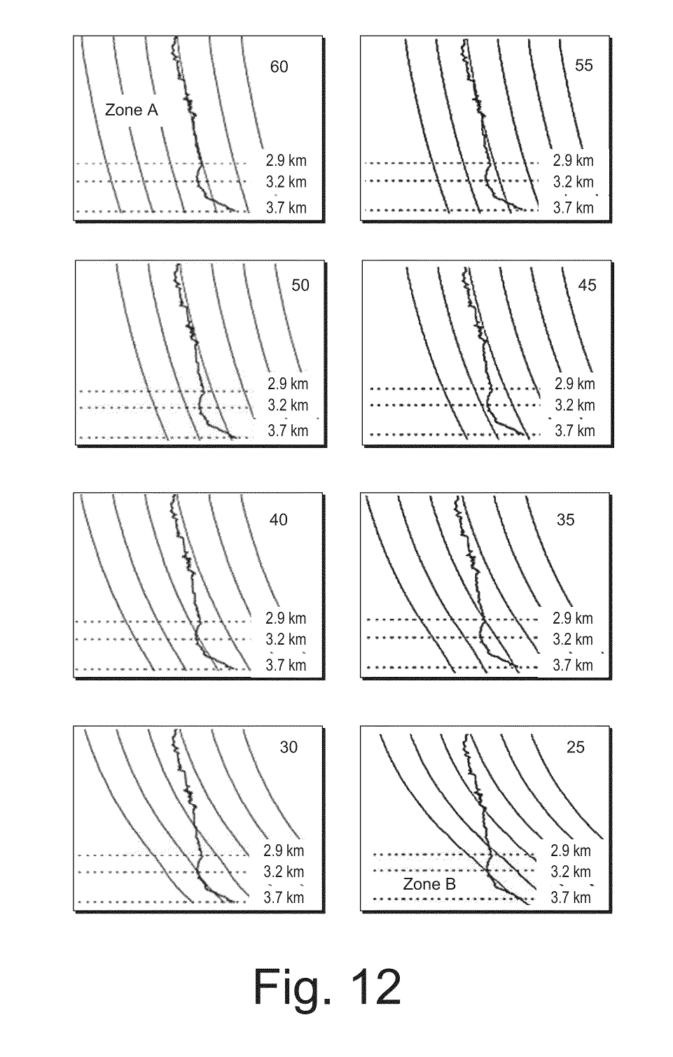

FIG. 12 shows example charts for various Q-factor values, particularly 60, 55, 50, 45, 40, 35, 30 and 25. In each of the charts, time domain stretch values are also shown with respect to time (e.g., depth). In the charts, curves are shown for the particular Q-factor values where slope may change with respect to depth (e.g., becoming less steep with respect to depth). As an example, a chart may be a plot of one way time versus time domain stretch where one way time may correspond to depth (see, e.g., depths of 2.9 km, 3.2 km and 3.7 km).

As mentioned, a lower Q-factor value may indicate greater attenuation (e.g., cycle loss) and, for example, greater stretch with respect to depth when compared to a higher Q-factor value. In the examples of FIG. 12, the charts may allow for a visual comparison to time domain stretch values, for example, as time difference values plotted with respect to time or depth. As an example, a method may perform a comparison using one or more algorithms. For example, consider an error minimization algorithm (e.g., a fitting algorithm, etc.).

In the examples of FIG. 12, a portion of the time domain stretch values may be approximated by synthetic values for a Q-factor of about 60 (e.g., Zone A) while another portion of the time domain stretch values may be approximated by synthetic values for a Q-factor of about 25 (e.g., Zone B). In such an example, the time domain stretch values may indicate multiple zones (e.g., Zones A, B, etc.) where the composition of two or more of the zones may differ. As mentioned, a higher Q-factor value may be indicative of a material with less attenuation (e.g., cycle loss).

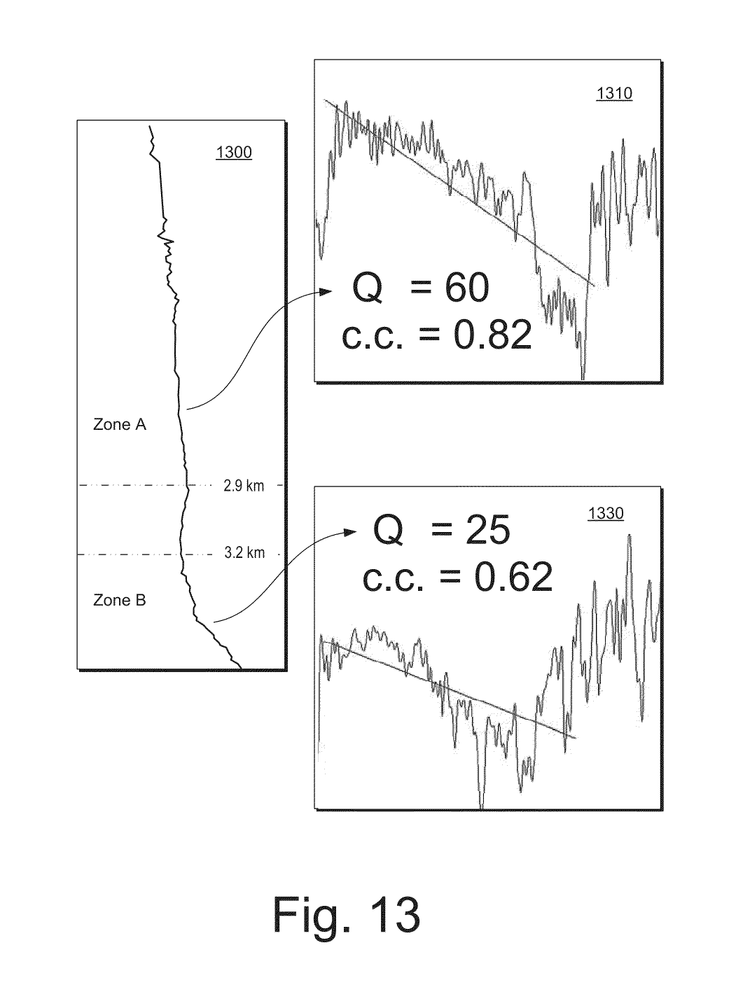

FIG. 13 shows example plots 1300, 1310 and 1330 from a method that includes spectral analysis, for example, using a spectral ratio technique. In such an example, for a portion of the seismic data, the spectral analysis indicates that a Q-factor value of about 60 (e.g., Zone A) may be assigned while, for another portion of the seismic data (e.g., Zone B), the spectral analysis indicates that a Q-factor value of about 25 may be assigned. The example plots 1310 and 1330 of FIG. 13 verify the estimates achieved via the approach explained with respect to FIG. 12.

As an example, results from a chart approach may be compared to other data. For example, the results illustrated in FIG. 12 were compared to lithology logs. The lithology logs included acoustic impedance data and gamma-ray data. In Zone A, the acoustic impedance and gamma-ray data exhibited characteristics that differed from those in Zone B. In particular, variation with respect to depth was greater in Zone A than in Zone B, especially for the gamma-ray data.

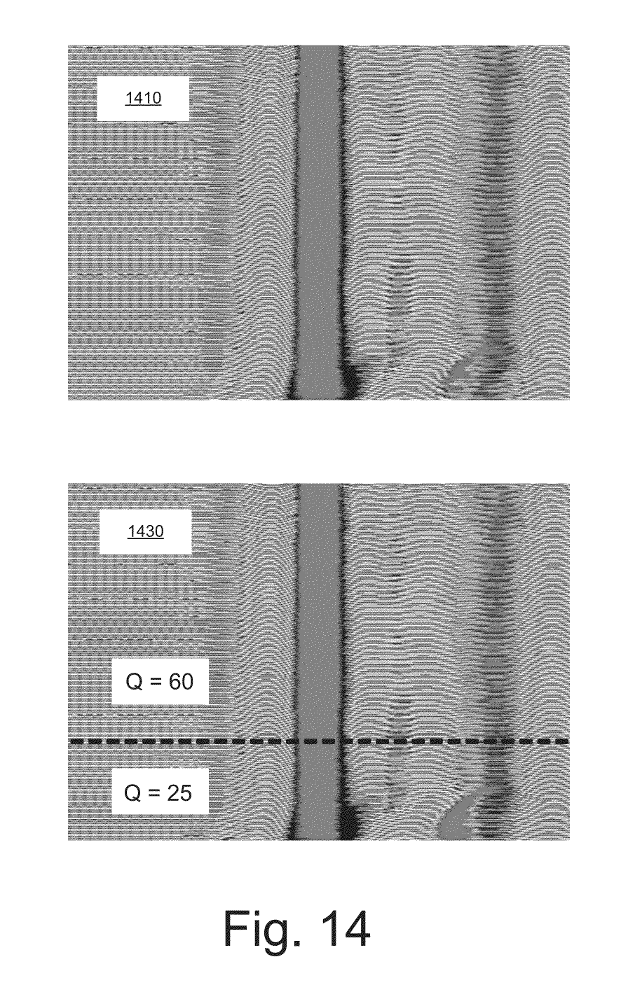

FIG. 14 shows example plots 1410 and 1430 associated with reverse Q-filtering, for example, in an effort to boost frequency (e.g., along at least a portion of an interval). In the plot 1410, results are shown for reverse Q-filtering using a Q-factor value of 60 over a range of depths (e.g., over a VSP interval). The plot 1410 illustrates frequency (e.g., stretch) recovery over a VSP interval. The plot 1430 shows results for reverse Q-filtering using a variable Q-factor where a first Q-factor value is applied for a first zone (e.g., a Q-factor value of about 60) and where a second Q-factor value is applied for a second zone (e.g., a Q-factor value of about 25).

As an example, a method can include accessing seismic traces (e.g., VSPs, etc.); determining time domain stretches for wavelets in the accessed seismic traces; providing a model; modeling scenarios for different Q-factor values; matching the determined stretches and to one or more of the scenarios; and outputting one or more Q-factor values for the accessed traces.

As an example, a method can include reverse Q-factor filtering to recover at least some frequency content lost due to attenuation.

As an example, a method can include generating Q-charts (e.g., as scenarios). As an example, a method may include outputting multiple Q-factor values with respect to depth. As an example, depth may correspond to a borehole depth for a borehole associated with seismic traces (e.g., a VSP).

As an example, a method can include analyzing one or more Q-factor values for accessed traces with respect to lithology data. As an example, a method can include repeating modeling scenarios for multiple zones.

As an example, a method can include determining stretches by analyzing amplitudes of wavelets in a time domain. In such an example, each of the stretches may be a time interval between a peak amplitude and a trough amplitude of a wavelet. As an example, the peak amplitude may be presented as a time of zero and the trough amplitude as a negative time representing a time prior to acquisition of the peak amplitude. As an example, a model may models trough amplitude times and peak amplitude times for wavelets with respect to depth. In such an example, each stretch for accessed seismic traces may represent a time difference between a respective peak amplitude time and a respective trough amplitude time.

As an example, one or more computer-readable storage media can include computer-executable instructions executable by a computer to instruct the computer to: access seismic traces; determine time domain stretches based on wavelets in the accessed seismic traces; provide a model; model scenarios for different Q-factor values; match the determined stretches and to one or more of the scenarios; and output one or more Q-factor values for the accessed traces.

As an example, a system can include a processor; memory operatively coupled to the processor; one or more modules stored in the memory and including instructions executable by the process to instruct the system to: access seismic traces; determine time domain stretches based on wavelets in the accessed seismic traces; provide a model; model scenarios for different Q-factor values; match the determined stretches and to one or more of the scenarios; and output one or more Q-factor values for the accessed traces.

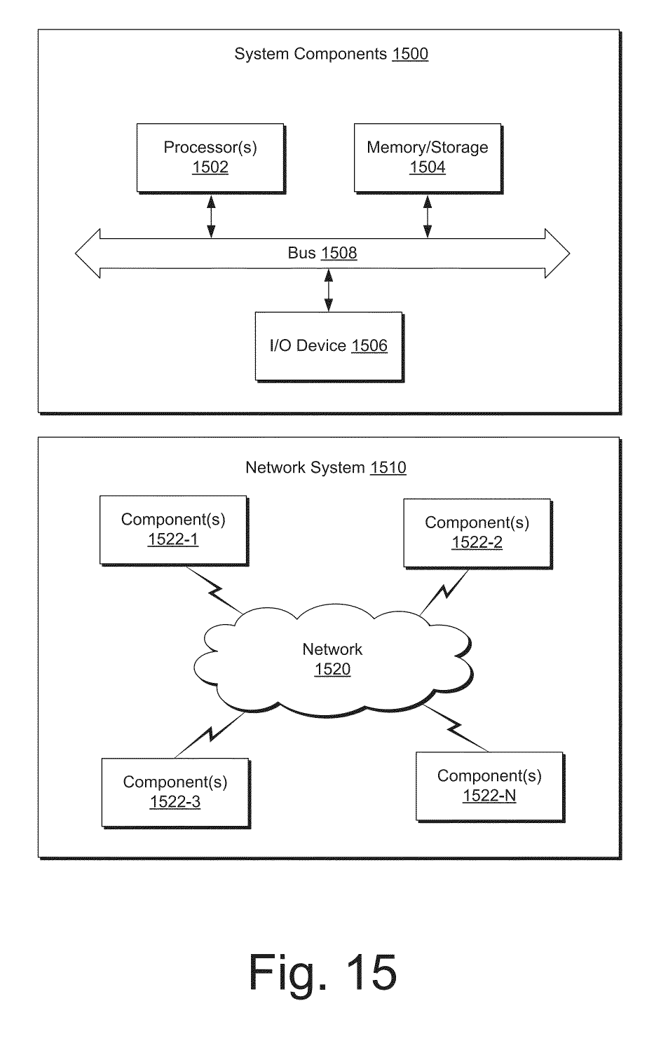

FIG. 15 shows components of an example of a computing system 1500 and an example of a networked system 1510. The system 1500 includes one or more processors 1502, memory and/or storage components 1504, one or more input and/or output devices 1506 and a bus 1508. In an example embodiment, instructions may be stored in one or more computer-readable media (e.g., memory/storage components 1504). Such instructions may be read by one or more processors (e.g., the processor(s) 1502) via a communication bus (e.g., the bus 1508), which may be wired or wireless. The one or more processors may execute such instructions to implement (wholly or in part) one or more attributes (e.g., as part of a method). A user may view output from and interact with a process via an I/O device (e.g., the device 1506). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1510. The network system 1510 includes components 1522-1, 1522-2, 1522-3, . . . , 1522-N. For example, the components 1522-1 may include the processor(s) 1502 while the component(s) 1522-3 may include memory accessible by the processor(s) 1502. Further, the component(s) 1502-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH®, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc., interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. A method comprising:
receiving seismic traces associated with a geologic environment;
determining time domain stretch values for individual wavelets in at least a portion of the seismic traces with respect to a spatial dimension of the geologic environment; and
estimating at least one Q-factor value for at least a portion of the geologic environment via a comparison of the time domain stretch values to a Q-factor model.

2. The method of claim 1, wherein the seismic traces comprises seismic traces of a vertical seismic profile (VSP).

3. The method of claim 1, wherein the individual wavelets comprises downgoing direct arrival wavelets.

4. The method of claim 1, wherein each of the time domain stretch values comprises a respective time difference value between a trough of an individual wavelet and a peak of the individual wavelet.

5. The method of claim 1, wherein each of the time domain stretch values comprises a respective time difference value between two points of an individual first downgoing P-wave arrival wavelet.

6. The method of claim 1, wherein each of the time domain stretch values comprises a respective time difference between two inflection points of an individual wavelet.

7. The method of claim 1, further comprising autocorrelating the seismic traces.

8. The method of claim 1, wherein the receiving comprises receiving autocorrelated seismic traces.

9. The method of claim 1, wherein the seismic traces comprise pneumatic energy source generated seismic traces.

10. The method of claim 1, wherein the seismic traces comprise vibroseis seismic traces.

11. The method of claim 1, further comprising applying reverse Q-filtering to at least a portion of the seismic traces using at least one of the at least one estimated Q-factor values.

12. A system comprising:
a processor;
memory accessibly by the processor;
one or more modules storable in the memory wherein the one or more modules comprise processor-executable instructions to instruct the system to
receive seismic traces associated with a geologic environment;
determine time domain stretch values for individual wavelets in at least a portion of the seismic traces with respect to a spatial dimension of the geologic environment; and
estimate at least one Q-factor value for at least a portion of the geologic environment via a comparison of the time domain stretch values to a Q-factor model.

13. The system of claim 12, wherein the one or more modules comprise processor-executable instructions to instruct the system to generate the Q-factor model.

14. The system of claim 13, wherein the Q-factor model comprises model information for a plurality of Q-factor values.

15. The system of claim 12, wherein the one or more modules comprise processor-executable instructions to instruct the system to perform reverse Q-filtering.

16. The system of claim 12, wherein the one or more modules comprise processor-executable instructions to instruct the system to acquire seismic traces.

17. One or more computer-readable storage media comprising computer-executable instructions executable by a computer to instruct the computer to:
receive seismic traces associated with a geologic environment;
determine time domain stretch values for individual wavelets in at least a portion of the seismic traces with respect to a spatial dimension of the geologic environment; and
estimate at least one Q-factor value for at least a portion of the geologic environment via a comparison of the time domain stretch values to a Q-factor model.

18. The one or more computer-readable storage media of claim 17, comprising computer-executable instructions executable by a computer to instruct the computer to generate the Q-factor model.

19. The one or more computer-readable storage media of claim 18, wherein the Q-factor model comprises model information for a plurality of Q-factor values.

20. The one or more computer-readable storage media of claim 17, comprising computer-executable instructions executable by a computer to instruct the computer to perform reverse Q-filtering.
